(19) United States
(12) Patent Application Publication
(10) Pub. No.: US 2026/0262687 A1
(43) Pub. Date: Sep. 10, 2026

(54) PURE FROZEN FRUIT SNACK

(71) Applicant: HUNDY Fruit Corp., Dallas, TX (US)

(72) Inventors: Michelle Elyse Solomon Schor, Dallas, TX (US); Aviv Schor, Dallas, TX (US)

(21) Appl. No.: 19/560,811

(22) Filed: Mar. 9, 2026

Related U.S. Application Data
(60) Provisional application No. 63/769,496, filed on Mar. 10, 2025.
(60) Provisional application No. 63/916,964, filed on Nov. 13, 2025.

(51) Int. Cl. A23L 19/00; A23B 7/045

(52) U.S. Cl. CPC A23L 19/03; A23B 7/045; A23L 19/09

(57) ABSTRACT

A fruit snack including chunks of fruit are frozen together into a bar or pop shape that holds together to be eaten directly from a package. The fruit snack is free from preservatives and added sugars. The disclosure also includes apparatus and methods of forming the fruit snack without requiring gelatin, pectin, jelly, or other additives, and with pleasing texture and chunk size. The methods can be used with individually quick frozen fruit or with fresh fruit to form a pure frozen fruit snack that is not overly icy and provides a mouth feel of actual fruit pieces.

### RELATED APPLICATIONS

This application claims the benefit of U.S. Provisional Application No. 63/769,496, filed on Mar. 10, 2025, and U.S. Provisional Application No. 63/916,964, filed on Nov. 13, 2025, which applications are incorporated herein by reference in their entirety.

### FIELD

Embodiments disclosed in the present disclosure relate to pre-packaged fruit snacks. More specifically, embodiments disclosed herein relate to individual-serving frozen fruit snacks. Some embodiments disclosed herein relate to a pure frozen fruit snack product. Some embodiments disclosed herein relate to apparatus and methods for producing a pure frozen fruit snack product.

### BACKGROUND

Prior frozen fruit snacks typically include additives, such as preservatives, added sugars, or jelly; such additives can be perceived as less healthy, may not be “organic”, and not non-GMO. Prior frozen fruit snacks are often pureed, mashed, or liquified prior to freezing; such mashed snacks lack the experience and appeal of eating real fruit pieces. The processing of such snacks can produce an icy snack that may not be appealing to consume.

The present disclosure provides improvements that address limitations associated with the prior art.

### BRIEF SUMMARY

Some embodiments disclosed herein include a pure frozen fruit snack, and methods of preparing a frozen fruit snack.

Some embodiments disclosed herein include a pure frozen fruit snack comprising chunks of Individually Quick Frozen fruit or fresh fruit, wherein the chunks can be about ⅛ inch×⅜ inch×⅜ inch, frozen into a unified structure. The frozen fruit snack can be consumed directly from a package without requiring utensils due to a unique seal. The frozen fruit snack can be prepared without additives such as sugars or preservatives. Some embodiments include methods of preparing a pure frozen fruit snack, including steps of providing Individually Quick Frozen (IQF) fruit, cutting the IQF fruit into fruit chunks about ⅛ inch by ⅜ inch by ⅜ inch, thawing the fruit chunks to about 28 F to about 38 F, filling the thawed fruit chunks into plastic package tubes using a custom piston filler machine, and refreezing the packaged thawed fruit chunks to form a unified frozen fruit pop. Some embodiments disclosed herein can include steps of providing fresh fruit ripened to about Brix 11-16 (dependent on the type and variety of fruit), cutting the fresh fruit into fruit chunks about ⅛ inch by ⅜ inch by ⅜ inch, filling the fruit chunks into package tubes using a piston filler machine, and freezing the packaged thawed fruit chunks to form a unified frozen fruit pop. Some embodiments disclosed herein include steps of providing pureed fruit, and wherein the step of filling the fruit chunks into package tubes includes filling pureed fruit together with the fruit chunks.

These and various other advantages and features of novelty which characterize embodiments disclosed in the present disclosure are pointed out with particularity in the claims annexed hereto and forming a part hereof. However, for a better understanding of the embodiments disclosed herein, their advantages and objects obtained by their use, reference should be made to the drawings which form a further part hereof, and to the accompanying descriptive matter, in which there are illustrated and described preferred embodiments.

### BRIEF DESCRIPTION OF THE DRAWINGS

In the drawings, in which corresponding reference numerals and letters indicate corresponding parts of the various embodiments throughout the several views, and in which the various embodiments generally differ only in the manner described and/or shown, but otherwise include parts corresponding to the parts in the other various embodiments;

FIG. 1A is a schematic illustration of a frozen fruit snack partially extended from a package tube, in accordance with embodiments of the present disclosure;

FIG. 1B is a schematic illustration of a sealed package tube, in accordance with embodiments of the present disclosure;

FIG. 2 is a schematic illustration of chunks of fruit being introduced into the package to prepare the frozen fruit snack of FIG. 1, in accordance with embodiments of the present disclosure;

FIG. 3 is an illustration of a portion of a fresh piece of fruit partially cut for preparation of the frozen fruit snack of FIG. 1, in accordance with embodiments of the present disclosure;

FIG. 4A is a schematic front view illustrating the sealed package of the frozen fruit snack of FIG. 1, in accordance with embodiments of the present disclosure, illustrating a bottom seal, and showing an upper seal with an extended portion and tear notch;

FIG. 4B is an illustration similar to that of FIG. 4A, but showing a rear view of the sealed package of the frozen fruit snack of FIG. 1, in accordance with embodiments of the present disclosure, further illustrating a fin seal;

FIG. 5 is a chart illustrating a process for preparation of the frozen fruit snack of FIG. 1 using Individually Quick Frozen fruit, in accordance with embodiments of the present disclosure;

FIG. 6 is a chart illustrating a process for preparation of the frozen fruit snack of FIG. 1 using fresh fruit, in accordance with embodiments of the present disclosure; and

FIG. 7 is a chart illustrating a process for preparation of the frozen fruit snack of FIG. 1 using fresh fruit and fresh pureed fruit, in accordance with embodiments of the present disclosure;

FIG. 8 is a schematic perspective view of a custom vertical form fill sealing (VFFS) machine for preparation of the frozen fruit snack of FIG. 1, in accordance with embodiments of the present disclosure;

FIG. 9 is a perspective view showing a portion of the VFFS machine illustrated in FIG. 8 in further detail, configured with a plurality of fill tubes for simultaneously filling a plurality of single-serving packages;

FIG. 10A is a cross sectional illustration of a portion of the VFFS machine illustrated in FIG. 9, showing a custom fill valve portion of one of the plurality of fill tubes, shown in a valve closed position;

FIG. 10B is a further detail view similar to that of FIG. 10A but showing a valve open position;

FIG. 11 is a side view of a package tube with a fin seal disposed along its length, similar to that of FIG. 4B, but including a tear notch along the fin seal of the package tube;

FIG. 12 is a top isometric view of a drop tube support with individual fin seal alignment guides extending therefrom via drop tubes;

FIG. 13A depicts a heater arm with a cutter attached to a bottom of the heater arm via a cutter support;

FIG. 13B depicts an alternate view of the heater arm with a cutter attached to a bottom of the heater arm via a cutter support; and

FIGS. 14A, 14B, 14C and 14D further depict the drop tube support and the heater arm with attached knife creating tear notches in the roll of thin-walled plastic tube.

### DETAILED DESCRIPTION

Some embodiments disclosed herein are directed to providing a pure frozen fruit snack without unwanted additives or preservatives. Some embodiments disclosed herein are directed to providing a pure frozen fruit snack that is a healthy, organic, food snack made with only fruit. Some embodiments disclosed herein are directed to providing a frozen fruit snack that has an appealing form and texture of real fruit. Some embodiments disclosed herein are directed to providing a frozen fruit snack that is not overly icy. Some embodiments disclosed herein are directed to providing an individual-portioned fruit snack that can be consumed without additional utensil, dish, mess, and with minimal packaging trash.

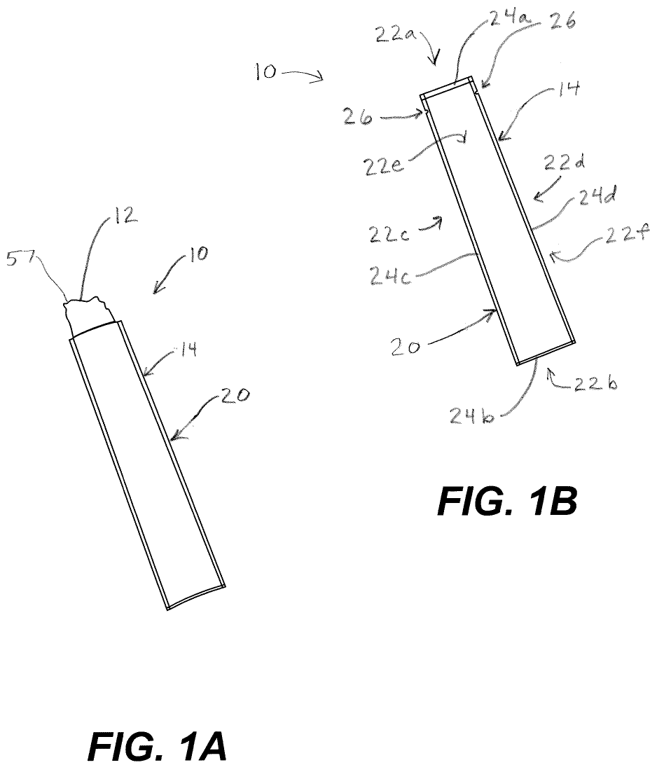

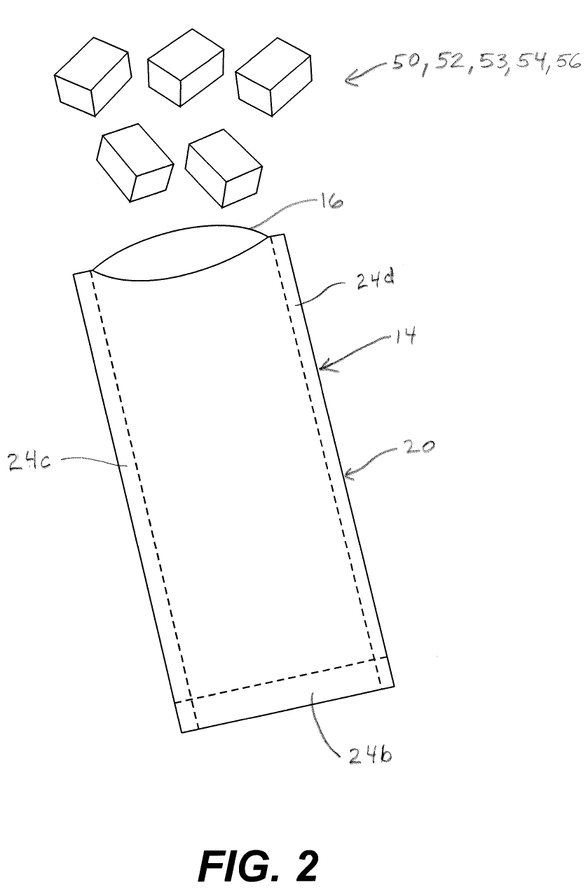

Referring now to the drawings, embodiments disclosed herein can include a pure frozen fruit snack 12 (which may be alternatively called herein a “pop”, “fruit pop”, “fruit snack”, or “frozen fruit snack”), and methods of producing a pure frozen fruit snack. In some embodiments disclosed herein, the pure frozen fruit snack 12 is configured as a single-portion packaged frozen fruit snack product 10, such as the example shown in FIG. 1A, which illustrates a single-serving pure frozen fruit snack 12 extending from a package 14. FIG. 1B shows a two-piece package tube 20 having a top seal 24a, a bottom seal 24d, and two tear notches 26 near the top of each side seal 24c and 24d. The pure frozen fruit snack 12 is enclosed within the package 14 and sealed with the top seal 24a. The top portion of the package 14 has been opened by a consumer, such as by tearing the package at a tear notch 26 to remove the top seal 24a and opening the package 14 in order to extend the pure frozen fruit snack 12 for consumption.

In some embodiments, the fruit snack 12 includes a plurality of fruit chunks 53, that clump or coalesce together when frozen together as described herein to form a unified structure 57 that can be easily extruded or extended from a suitably-shaped package 14 such as package 20 or package 30 described herein. In some embodiments, the pure frozen fruit snack 12 can be removed from the package 14 completely for consumption. In some embodiments, the pure frozen fruit snack 12 includes a stick, straw, or similar element (not shown) to facilitate manipulation and handling of the pure frozen fruit snack 12 during consumption; such element can be an edible element to reduce waste, or non-edible element such as a plastic or wooden stick.

The package 14 can be configured in a variety of shapes. In some embodiments, the shape of the package 14 facilitates opening and consuming the pure frozen fruit snack 12 without requiring a utensil, and with minimal mess. The shape of the package 14 can be chosen to define the shape of the pure frozen fruit snack 12 contained therein, such as an elongated pop, tube, stick, or bar. In some embodiments, the pure frozen fruit snack 12 is packaged in individual or single portion size, and in a manner that the pure frozen fruit snack 12 can be consumed without requiring a utensil or transfer to another dish for consumption. In some embodiments, the package 14 can be opened by tearing off an opening portion, such as by having at least one slit, score, perforation, thinner portion, or notch, so that the opening portion can be opened to access the pure frozen fruit snack 12 snack manually, without requiring a knife, scissors, or other opening device. For example, some embodiments include at least one tear notch such as tear notch 26, tear notch 36, or tear notch 46 illustrated herein. In some embodiments, the shape of package 14 provides an opening portion at least as wide as other portions of the package 14, so that the pure frozen fruit snack 12 can be pushed, extended, or extruded through the opening portion. Some embodiments include an elongated rectangular or tubular shape package 14 such the two-piece package tube 20, the one-piece package tube 30, or the one-piece package tube 40 illustrated herein; other shapes can be used in particular applications. As disclosed above, in some embodiments, the pure frozen fruit snack 12 can have an elongated stick such as a plastic or wooden stick or straw (not shown) to facilitate handling of the pure frozen fruit snack 12; in some embodiments, the pure frozen fruit snack 12 can be extended from the package and consumed without a stick, in order to minimize the need to dispose of or recycle the stick after consuming the fruit snack 12. We have learned that containing the fruit snack 12 pure frozen fruit snack 12 in a package 14 comprising package film 16, such as plastic or polymer sheet material, is superior to utilizing foil packaging, and provides a longer shelf life. The thickness of the package film 16 is chosen to allow the fruit snack 12 to freeze properly with a desired rigidity into a desired form, such as in a package 14 having an elongated rectangular or tubular shape that facilitates forming a single-serving pure frozen fruit snack 12 that can be easily held by hand and extended from the package 14 for consumption. The thickness of the plastic material or film 16 is chosen to allow the fruit snack 12 to freeze with less ice and more juice to provide the optimal taste. Plastic packaging material or film 16 that is too thin can produce a fruit pop or fruit snack 12 with a less-desirable icy consistency, and plastic packaging material or film 16 that is too thick can interfere with efficient freezing of the fruit snack 12.

A variety of fruit 50 can be utilized for embodiments disclosed herein, such as, but not limited to, mango, kiwi, pomegranate, pineapple, plantain, banana, blueberry, raspberry, blackberry, strawberry, grapefruit, passionfruit, dragonfruit, grape, cherry, and stone fruits. In some embodiments, the fruit 50 includes fresh fruit 52, which can be processed into fruit chunks 53 to facilitate forming the fruit snack 12. In some embodiments, the fruit 50 includes Individually Quick Frozen (IQF) fruit 54, processed into fruit chunks 53. In some embodiments, the fruit 50 includes 100% fruit puree 56; that is, a puree that is 100% fruit, with no sugars or other additives. In some embodiments, a single fruit 50 is used to form the pure frozen fruit snack 12. In some embodiments, the pure frozen fruit snack 12 includes a combination of different fruits 50. In some embodiments, a combination of fruit chunks 53 and fruit puree 56 is included in the fruit snack 12. In some embodiments, the fruit 50 includes one or more of the following: fresh fruit 52, IQF fruit 54, and 100% fruit puree 56. In some embodiments, processing steps can be used for some of the fruit 50 but not for other of the fruit 50, such as thawing IQF fruit 54 but not thawing fresh fruit 52, or processing some fruit 50 into fruit chunks 53 but not processing other fruit 50 into chunks such as pomegranate seeds, berries, or other smaller fruits.

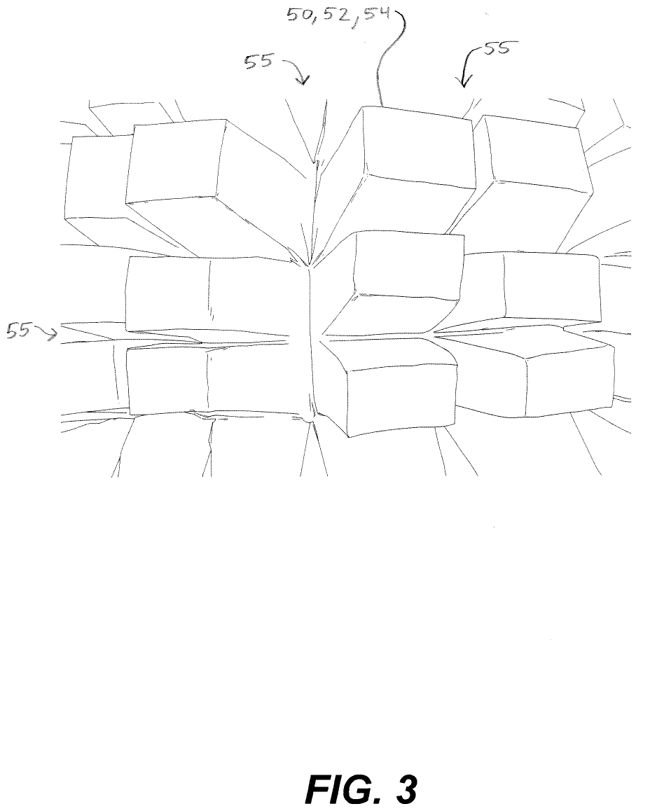

In some embodiments, the fruit 50 is processed into fruit chunks 53 to facilitate forming the fruit snack 12. A number of fruit chunks 53 are schematically illustrated in FIG. 2, along with an example package 14. Experimentation with a variety of sizes and configurations of fruit chunks 53 has shown that for forming the fruit snack 12, the optimal fruit chunks 53 are roughly parallelepiped shaped, approximately ⅜ inch by ⅜ inch by ⅛ inch, although some deviation from this configuration can still achieve acceptable results, including conical, tetrahedral, or irregular shapes, as long as the dimensions of the fruit chunks 53 are roughly in the range of about 1/16 to ½ inch. The optimal size and shape of the fruit chunks 53 can vary somewhat according to the choice of fruit 50 being utilized. We have learned that if the fruit chunk 53 sizes are too small, the resulting fruit snack 12 is more like a frozen mush or sauce product and is less desirable. We have also learned that if the fruit chunk 53 sizes are too large, the resulting fruit snack 12 has large frozen pieces, and the juice/solid mix will be less enjoyable to eat.

In some embodiments, the fruit chunks 53 are cut with a minimum dimension no less than about 1/16 inch and a maximum dimension no more than about ½ inch, and a volume between about 0.002 and about 0.14 cubic inches. In some embodiments, the fruit chunks 53 are cut with a minimum dimension about ⅛ inch and a maximum dimension about ⅜ inch. In some embodiments, the fruit chunks 53 have a volume between about 0.008 and about 0.07 cubic inches. In some embodiments, the fruit chunks 53 are cut with dimensions about ⅛ inch by ⅜ inch by ⅜ inch.

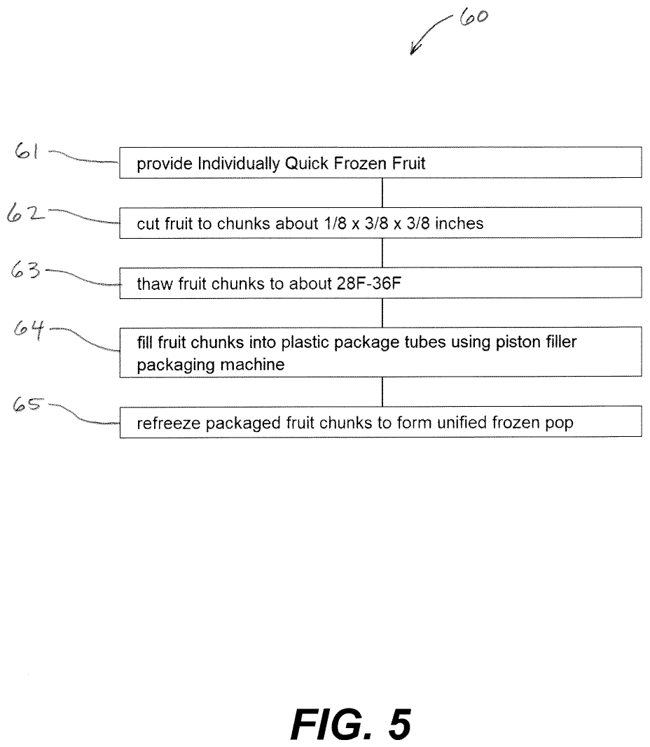

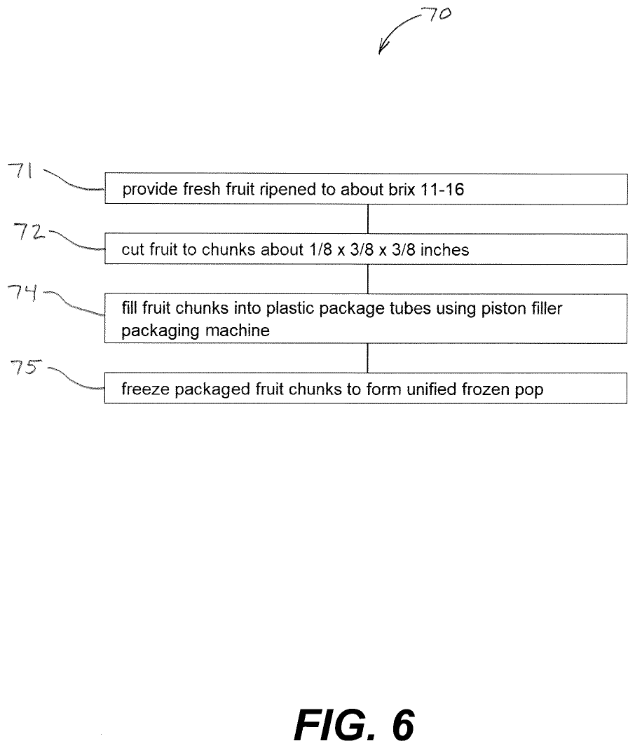

In some embodiments, the package 14 is a long roll of thin-walled plastic tube, that can either be a tubular extruded material, or 2 layers of flat plastic sheet material or package film 16 sealed or bonded along both sides, or a single layer of flat plastic sheet material or package film 16 folded over and sealed along one side to form a tube. In some embodiments, the package 14 will have one seal along a back or backside or rear of the package 14. In some embodiments, the plastic material or package film 16 has a thickness of about 0.002 inches plus a 60-gauge nylon layer, making a total thickness of 0.0026 inches. In the illustration of FIG. 2, the package 14 has a bottom portion or bottom 22b that is sealed to form a bottom seal 24b, and side portions pr sodes 22c. 22d that are sealed to form side seals 24c, 24d, indicated by the dashed lines in FIG. 2. After filling the package 14 with the fruit chunks 53, a packaging machine such as a vertical form fill seal (VFFS) machine 90 seals a top portion or top 22a as well. In some embodiments, the vertical form fill seal (VFFS) machine 90 is used to form a package 14 configured as a one-piece package tube 30 with a fin seal 34e, with the upper or top seal 34a formed after the fruit chunks 53 have been introduced, simultaneously forming the bottom seal 34b of the next single-serve tubular package of one-piece package tube 30 and cutting in the top/bottom seal area 34a, 34b and cutting or scoring a tear notch 36 to form the completed single-serve packaged pop or frozen fruit snack product 10. In some embodiments, the tear notch 36 is a laser etched line that forms a thinned or perforated structure to facilitate manually tearing open the package 14. The package 14, after filling with the fruit 53 and sealing, is subsequently frozen to form a pop or frozen fruit snack product 10, with the frozen fruit snack or pop 12 inside the package 14. In some embodiments, the top seal 34a has a nominal top seal depth 35c, but has an extended portion 35 with an extended portion depth 35a that extends below the rest of the top seal 34a, with the tear notch 36 located in this extended portion 35 to facilitate reliable opening of the package 14 to access the frozen pop or fruit snack 12 by a consumer. In these embodiments, the extended portion 35 has an extended portion width 35b that is of sufficient width to accommodate a tear notch 36 with a tear notch length 37b that facilitates opening of the package 14 while minimizing inadvertent opening or leaking. Preferably, the package 14 is configured so that the extended portion 35 and tear notch 36 is located at one side 32c or 32d of the packaged fruit snack product 10, and the fin seal 34e is located along the back or rear 32f of the packaged fruit snack product 10, such as illustrated in FIGS. 4A and 4B. The fin seal 34e creates a fin with a fin width 34f. As non-limiting examples only, in order to facilitate understanding of the embodiments disclosed herein, in some embodiments consistent with the present disclosure, the package or package tube 14 is about 1.8 inches inside width, about 8 inches total length, with about 0.61 inch top seal 34a, about 0.5 inch bottom seal 34b, with about 0.375 inch fin seal 34e, and about 0.32 inch extended portion 35 below the rest of the top seal 34a, and has a tear notch 36 about 0.11 inch below the rest of the top seal 34a. These example dimensions provide for a convenient single-serving pure-fruit frozen fruit snack 12 and packaged frozen fruit snack product 10; for example, about a 3-ounce frozen fruit snack 12.

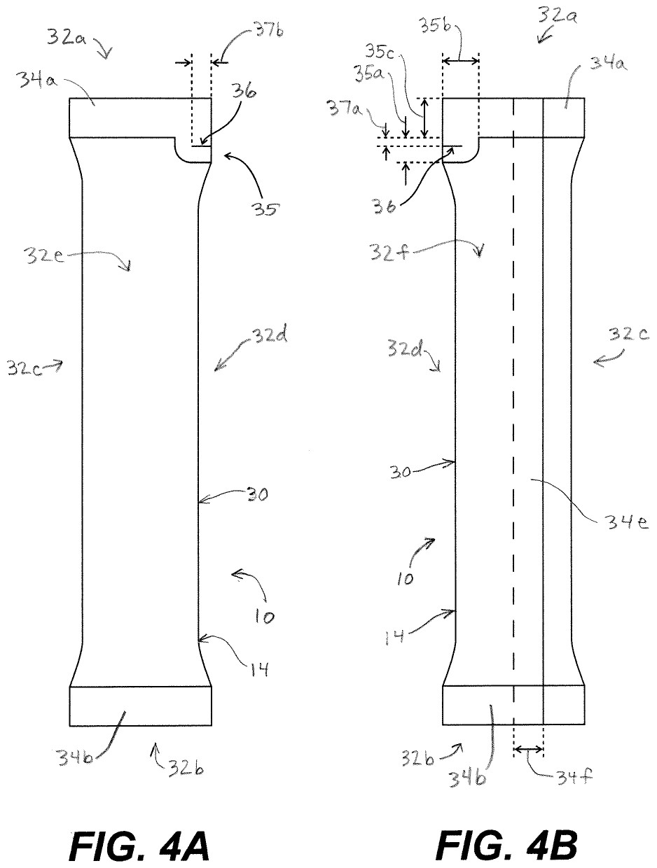

In some embodiments, the fruit 50 is cut into fruit chunks 53, such as by initial slicing of the fresh fruit 52 fruit as illustrated in FIG. 3 using specific machinery to form initial slices 55, and then cut into separate fruit chunks 53 that are introduced into the package or package tubes 14, 20, 30, 40.

In some embodiments, the fruit snack 12 is packaged using a packaging machine having a piston filler mechanism 93, with adjustable fill volume, with suck-back feature, that can vertically fill the packages 14, cutting and thermally sealing each package 14 from a long package film roll 92 of package film 16, such as the VFFS machine 90. In some embodiments, the VFFS machine 90 forms a cut or scored tear notch 36 with a custom chad at the side of the sealed package 30, below the upper or top seal 34a, to facilitate tearing the package 30 open by hand to consume the fruit snack 12. In some embodiments, the machine has filling channels that can accommodate the size of fruit chunks 53 being utilized to form the particular fruit snack 12 being packaged; typical filling machines are adapted for filling juice, sauce, or puree food, and cannot accommodate fruit chunks 53 in the range of up to about 1/2 inch in size. In some embodiments, the VFFS machine 90 produces 80 to 100 filled tubes or packages 14 per minute and has a fin seal 34e along the back of the tube rather than seals 24c, 24d on each side 22c, 22d of the tube or package 20, 30, 40 which could cut the consumer's mouth.

Some embodiments disclosed herein provide a frozen fruit snack 12 that is free of additives such as preservatives, added sugars, gelatine, pectin, or jelly, and can be utilized with fruit chunks 53 rather than juiced, blended, pureed, mashed, macerated, finely chopped, or liquified fruit. Some embodiments disclosed herein provide pure fruit 50, in an appealing form that, when consumed, provides a satisfying texture of consuming actual fruit, rather than a frozen juice, mush, or sauce. Some embodiments disclosed herein facilitate forming an “organic” fruit snack 12 due to avoidance of additives. Some embodiments disclosed herein facilitate forming a “non-GMO” fruit snack 12, that is, not including any genetically modified organisms. Some embodiments disclosed herein provide the experience and appeal of eating real fruit pieces 50, 52, 54, and avoid excessive ice formation that can occur in prior art frozen fruit snacks. Some embodiments disclosed herein provide a frozen fruit snack 12 with a unified structure 57, more like a pop, rather than a mush that is squeezed out of a package, which may be the case with prior art fruit snacks.

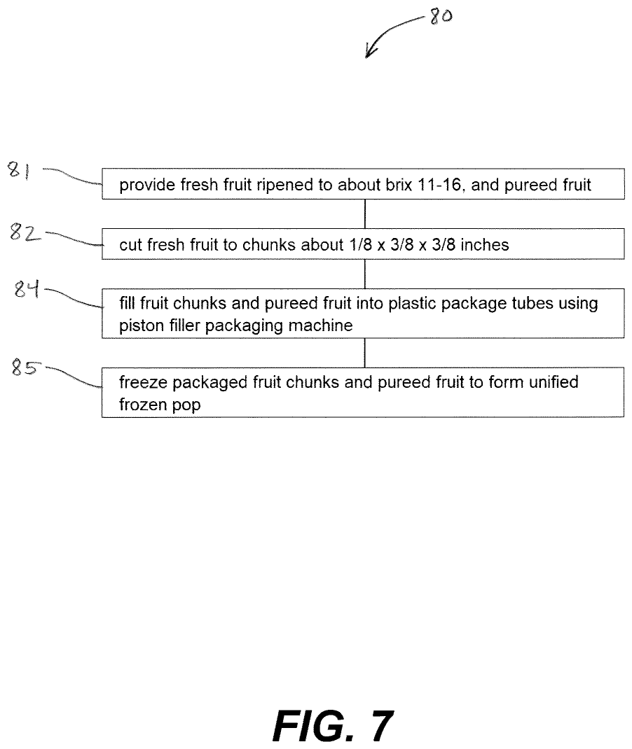

Some embodiments disclosed herein include a method 60 for producing a pure frozen fruit snack such 12 as is outlined in FIG. 5, including the step 61 of providing Individually Quick Frozen (IQF) fruit 54, the step 62 of cutting the IQF fruit 54 into fruit chunks 53 about ⅛×⅜×⅜ inches in size. This method further includes the step 63 of thawing the fruit chunks 53 to about 28 F-38 F, which causes some juice to be released from the fruit chunks 53; in some embodiments, the fruit chunks 53 are thawed to about 36 F. This process provides a material that is mostly fruit chunks 53, with a small amount of juice released from the fruit chunks 53. This method includes the step 64 of filling the fruit chunks 53 and juice filled together into packages 14, sealed, and the step 65 of freezing the sealed packaged frozen fruit snack product 10 to form a pure frozen fruit snack 12 or pop having a unified structure 57. In some embodiments, a piston filler packaging machine such as the VFFS machine 90 is used to fill and seal the packages 14. In some embodiments, a small amount of additional juice can be utilized in order to achieve a juice/solid mix that is enjoyable to eat, or to achieve a desirable texture in the frozen fruit snack 12 that is neither too solid nor too soft as it is consumed.

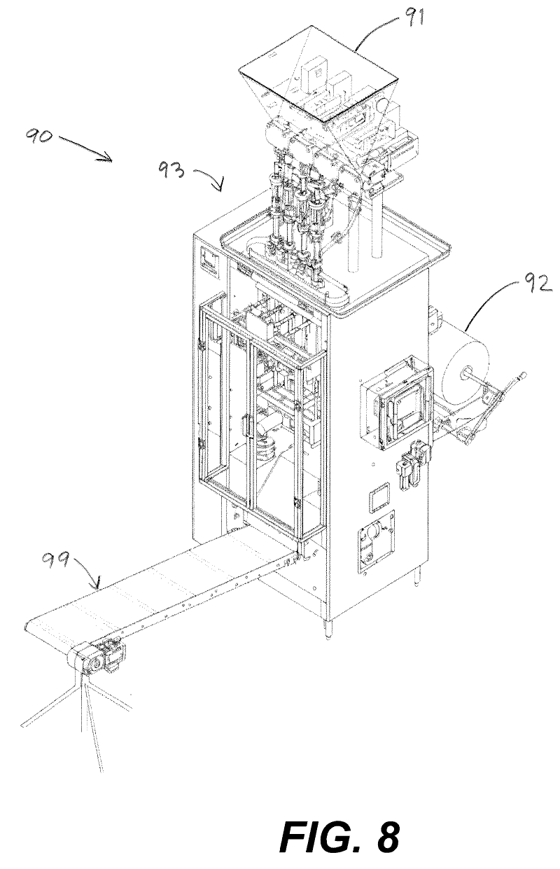

Some embodiments disclosed herein include a method 70 for producing a pure frozen fruit snack 12 such as is outlined in FIG. 6, including the step 71 of providing fresh fruit 52 ripened to about brix 11-16. In some embodiments, the method includes the step 72 of cutting the fresh fruit 52 into fruit chunks 53 about ⅛×⅜×⅜ inches in size. This method includes the step 74 of filling the fruit 52 or fruit chunks 53 into package 14 and sealing the package 14, and the step 75 of freezing the sealed package 14 to form a pure frozen fruit snack 12. In some embodiments, a piston filler packaging machine such as the VFFS machine 90 is used to fill and seal the packages 14 prior to freezing the contents to form the frozen fruit snack 12.

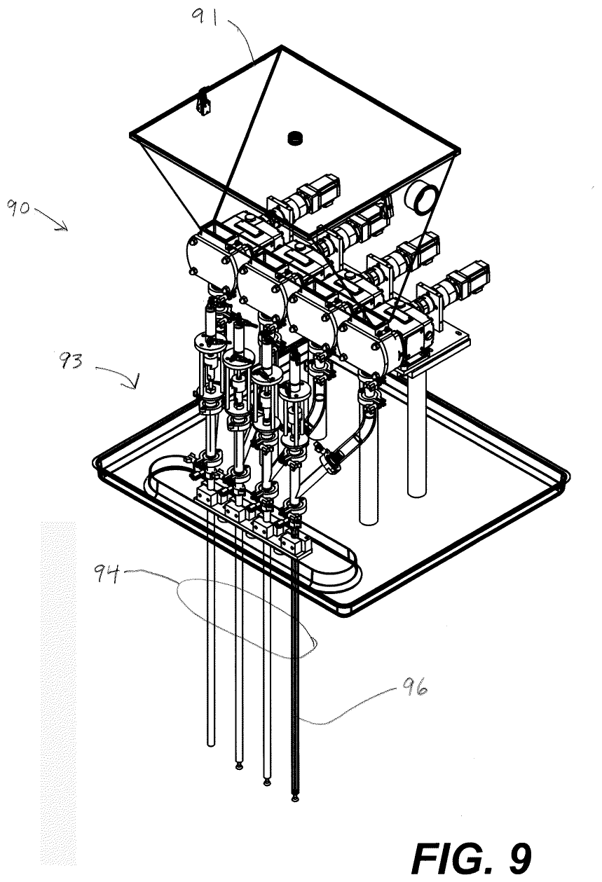

Some embodiments disclosed herein include a method 80 for producing a pure frozen fruit snack 12 such as is outlined in FIG. 7, including the step 81 of providing fresh fruit 52 ripened to about brix 11-16 together with fruit puree 56. In some embodiments, this method includes the step 82 of cutting the fresh fruit 52 into fruit chunks 53 about ⅛×⅜×⅜ inches in size. This method includes the step 84 of filling package 14 with a mixture of the fruit 52 and the fruit puree 56, or the fruit chunks 53 and the fruit puree 56, into package 14 and sealing the package 14, and the step 85 of freezing the sealed package 14 to form a pure frozen fruit snack 12. In some embodiments, a piston filler packaging machine such as the VFFS machine 90 is used to fill and seal the package 14.

Combinations of steps selected from more than one of the illustrative methods herein described may be combined, such producing a frozen fruit pop 12 that includes small fruit 50 such as berries, which may not require cutting into fruit chunks 53, but also includes fruit 50 such as pineapple or mango, which may require cutting into fruit chunks 53, to produce a frozen fruit snack 12 that includes a plurality of fruits 50. Similarly, in some embodiments of the frozen fruit snack product 10, the frozen fruit snack 12, or methods 60, 70, or 80, combinations of the various fruits 50 can be incorporated, such as combining fresh fruit 52 and/or fruit chunks 53 with fruit puree 56 or by combining with additional fruit juice.

In some embodiments, the VFFS machine 90 is configured for simultaneously preparing and filling and sealing a plurality of packages 14 to provide for a more efficient production of the frozen fruit snack product 10.

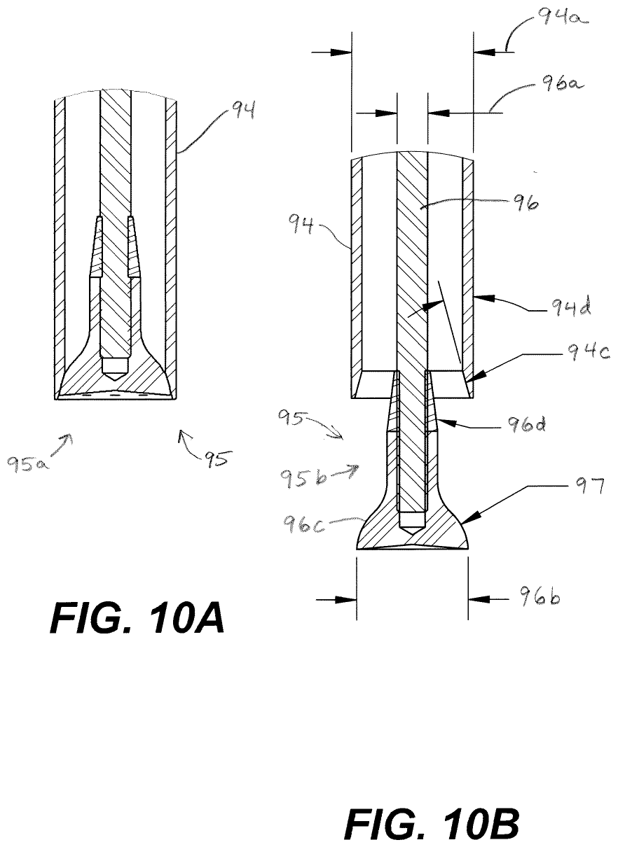

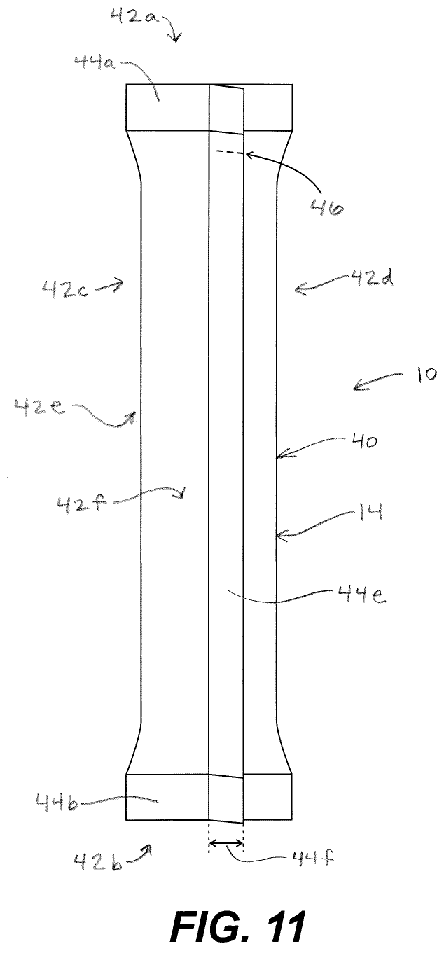

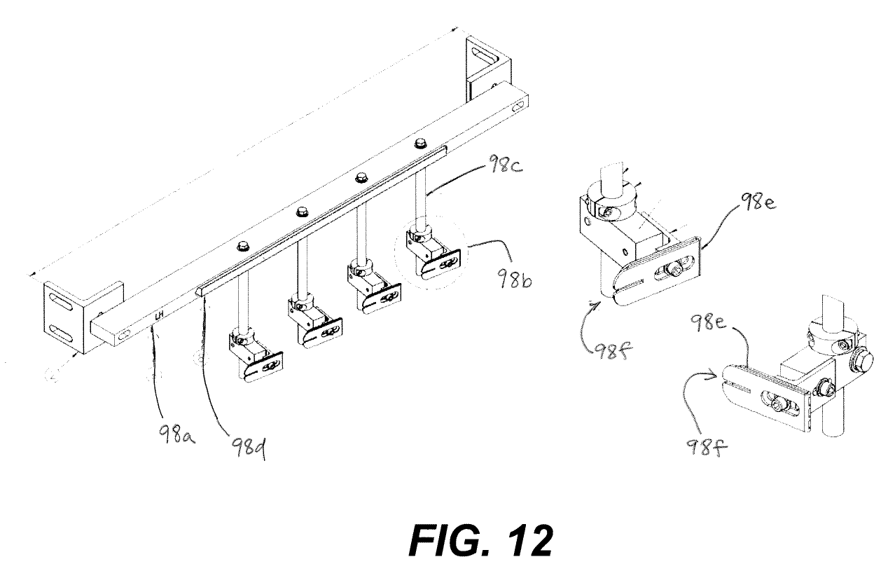

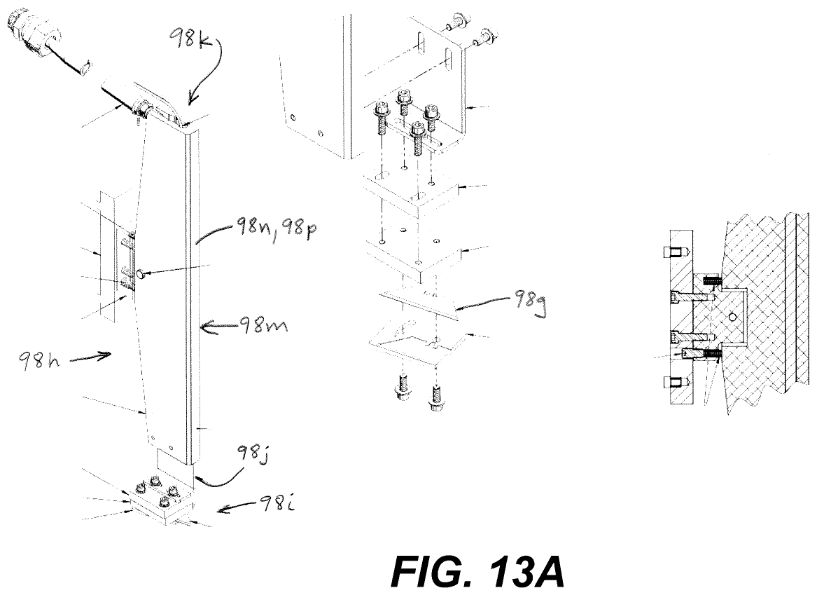

In some embodiments, a custom VFFS machine 90 is configured for packaging the fruit 50 such as the fruit chunks 53 which are subsequently frozen to form the frozen fruit snack 12 or pop. FIG. 8 illustrates an example of such a VFFS machine 90, with a fill hopper 91 at the top portion, package film roll 92 at the rear, one or more fill tubes 94 near the front, and a conveyor 99 extending from the front to transfer the packaged fruit 50 prior to freezing to form frozen fruit snacks 12. A portion of the custom VFFS machine 90 is illustrated in FIG. 9, which shows the fill hopper 91 and a plurality of fill tubes 94, which can utilize pneumatic-actuated seal valves or fill valves or cutoff valves 95 such as illustrated. In the illustration of FIG. 9, there are 4 fill tube 94 assemblies that are independently actuated, each with a fill valve 95. The geometry of the fill tubes 94 and fill valves 95 is particularly adapted for filling the fruit chunks 53 into the packages 14. We have discovered that conventional VFFS machine fill and seal valves do not work well with fruit chunks 53 such as those of embodiments disclosed herein, and will not reliably seal or open to pass such fruit chunks 53. In order to accommodate such fruit chunks 53, the fill tube diameter 94a must be sufficient to pass the fruit chunks 53, allowing for the plug shaft 96. In addition, a configuration of the fill valves 95 incorporating an angled tube sealing face 94c, with a rounded or spherical section plug sealing face 97, provide an improved function of the fill valve 95. Further, a jam nut 96d may be used to secure the plug 96c to the plug shaft 96; a tapered jam 96d nut facilitates passage of the fruit chunks 53 past the fill valve 95 when the valve is open, reducing clogging. An example geometry of the fill valve 95 is illustrated in a valve closed position 95a in FIG. 10A, and in a valve open position 95b in FIG. 10B.

For purposes of illustrative example only, some embodiments can include a fill tube 94 having a fill tube outer diameter 94a of about 0.75 inch; some embodiments can include a plug shaft diameter 96a of about 0.19 inch. Some embodiments can include an angled tube sealing face 94c with a sealing angle 94d of about 15 degrees with respect to vertical. Some embodiments include a plug 96c having a plug diameter 96b of about 0.687 inch, with a spherical-section plug sealing face 97 having a spherical radius of about 0.344 inch. When open, the geometry of the fill valve 95 will pass fruit chunks 53 up to about 0.28 inch in smallest dimension, and when closed, the spherical plug sealing face 97 seals against the angled tube sealing face 94c along a circular line around the angled tube sealing face 94c that is somewhat smaller in diameter than the fill tube outer diameter 94a of the fill tube 94. While these dimensions are illustrative examples, some variation in any or all of these dimensions can be utilized, depending on the particular fruit chunks 53 being packaged to form the frozen fruit snacks 12.

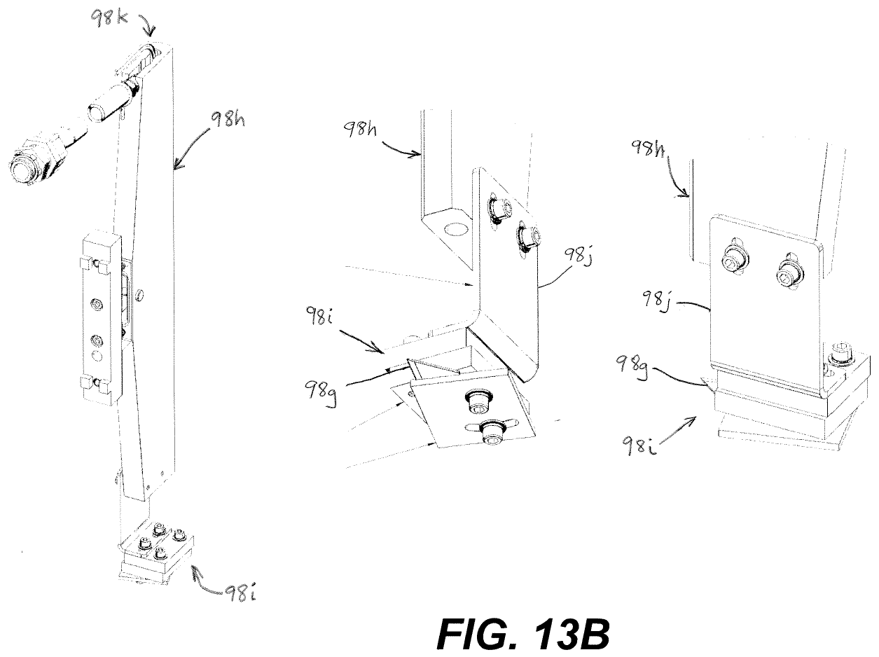

FIG. 11 is a side view of a generally tubular package 14, 40 having a fin seal 44e disposed along its length. In some embodiments, a tear notch 46 can be defined along the fin seal 44e of the package 14, 40, as depicted in FIG. 11. In use, a user can grab a portion of the package 40 and/or fin seal 44e above and below the tear notch 46 and tear the package 40 tube open via a weakened spot created at the tear notch 44e. Positioning the tear notch 46 along the fin seal 44e can better prevent accidental contact and tearing of the package 40 in contrast to a package 14 that includes a tear notch disposed along a tubular portion of the package 14. In some embodiments, a more streamlined packaging can be obtained by having the tear notch 46 disposed along the fin seal 44e, eliminating notches that might otherwise exist along portions of the package 40 that displays advertising, etc.

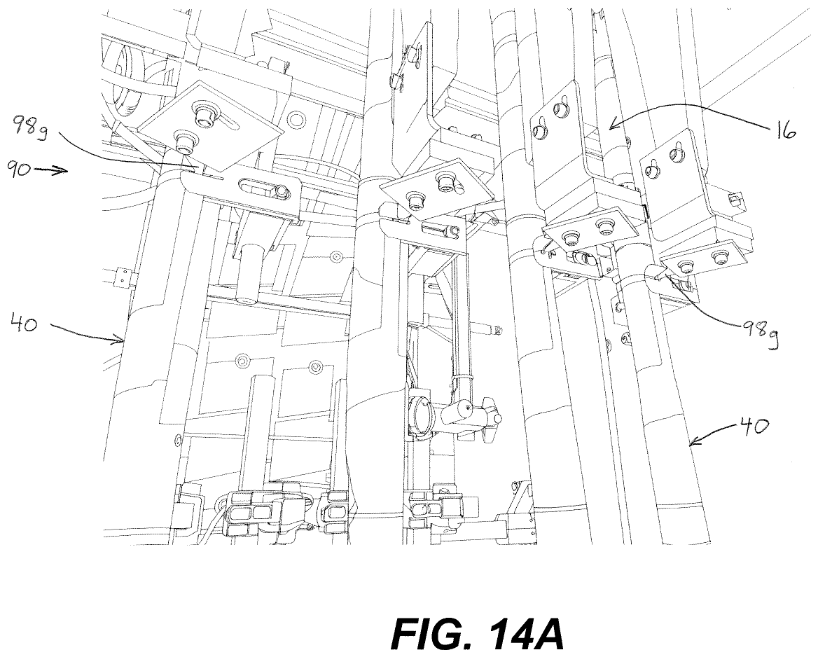

FIG. 12 is a top isometric view of a portion of the VFFS machine 90 illustrating a drop tube support 98a, with individual fin seal alignment guides 98b extending therefrom via drop tubes 98c. In some embodiments, as depicted herein, a long roll of thin-walled plastic film 16 can be passed over the drop tube support 98a and over silicone bumper 98d. The fin seal 44e can be passed through a tab support 98e, which includes a slot 98f through which a knife or blade 98g can pass to create a tear notch 46 in the package 14.

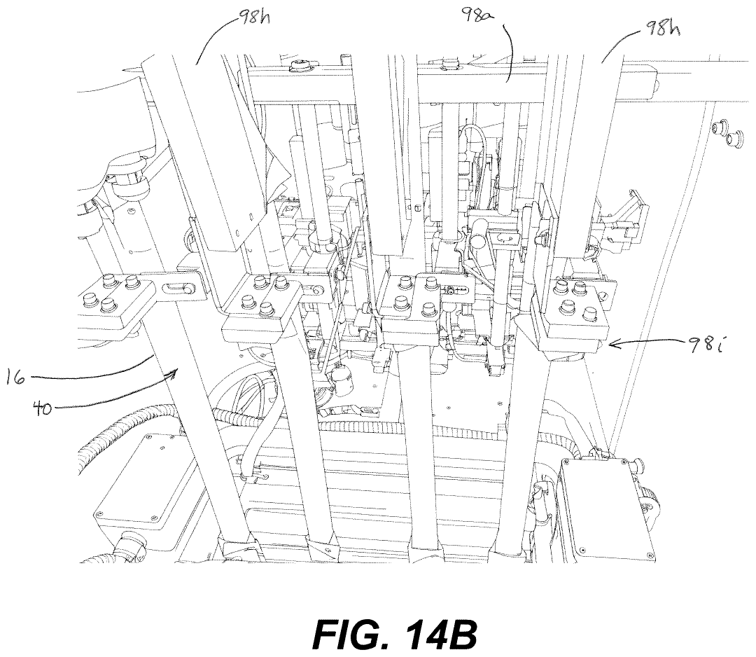

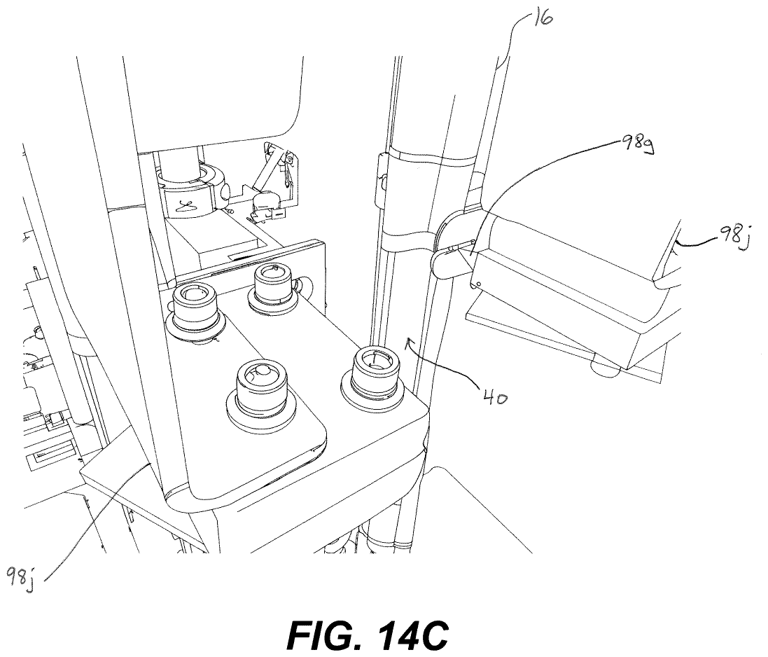

FIG. 13A depicts a heater arm 98h with a cutter 98i attached to a bottom of the heater arm 98h via a cutter support 98j. As depicted in FIG. 13A, the heater arm 98h can include a heater 98k that extends therethrough, which heats a sealing surface 98m of the heater arm 98h. In some embodiments, the sealing surface 98m can include a non-stick tape 98n disposed on the sealing surface of the heater, which can be a Teflon tape 98p, in some embodiments. In some embodiments, the sealing surface 98m of the heater arm 98h can contact the silicone bumper 98d of the drop tube support 98a, thereby pinching a select portion of the roll of thin-walled plastic tube or package film 16 between the sealing surface 98m and the silicone bumper 98d, causing the select portion of the roll of thin-walled plastic tube or package film 16 to be sealed. In some embodiments, one or more of the drop tube support 98a and the heater arm 98h can be moved such they contact one another.

As a result of the movement of the blade 98g relative to the drop tube support 98a and the heater arm 98h, the blade 98g can be moved and contact can occur between a fin seal portion of the roll of thin-walled plastic tube or package film 16, thereby creating a tear notch 46 in the fin seal 44e.

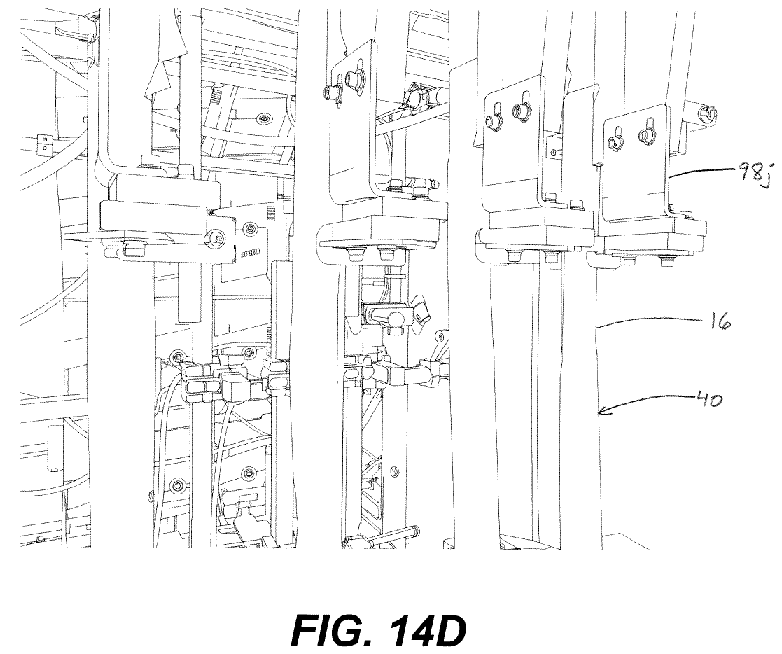

FIG. 13B depicts an alternate view of the heater arm 98h with a cutter 98i attached to a bottom of the heater arm 98h via a cutter support 98j. FIGS. 14A to 14D further depict the drop tube support 98a and the heater arm 98h with attached blade 98g creating tear notches 46 in the thin-walled plastic tube or package film 16.

Various embodiments are described herein of various apparatus and/or systems. Numerous specific details are set forth to provide a thorough understanding of the overall structure, function, manufacture, and/or use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” “an exemplary embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” “in an exemplary embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

As used herein, terms such as “inside”, “outside”, “inner”, “outer”, “height”, “width” “thickness”, “top”, “bottom”, “side”, “above”, “below”, and so forth generally are used herein with their ordinary meaning, consistent with the drawings herein. These general direction and orientation indications are used herein for clarity of presentation, but are not necessarily intended to be limiting. For example, the “width” of an element may be longer than the “length” of the element, and “height” may be used to describe a vertical dimension of an element, but still used if in some views or embodiments that element is oriented horizontally, for consistency and clarity of presentation, unless such interpretation would be inconsistent with the teachings of the present disclosure. Some elements disclosed herein can be oriented or ordered differently but within the scope of the present disclosure, to the extent that such variations are not illogical or non-functional, and are consistent with the teachings of the present disclosure in view of the art.

Exemplary claims include the following:
1. A frozen fruit snack comprising: fruit chunks, wherein the fruit chunks are cut with a minimum dimension no less than about 1/16 inch and a maximum dimension no more than about ½ inch, and a volume between about 0.002 and about 0.14 cubic inches; the frozen fruit snack is packaged in an individual-portion package that can be opened and consumed without utensil; and the frozen fruit snack is formed as a unified structure.
2. The frozen fruit snack of claim 1, wherein the fruit chunks have a volume between about 0.008 and about 0.07 cubic inches.
3. The frozen fruit snack of claim 1, wherein the fruit chunks are cut with a minimum dimension about ⅛ inch and a maximum dimension about ⅜ inch.
4. The frozen fruit snack of claim 1, wherein the fruit chunks are cut with dimensions about ⅛ inch by ⅜ inch by ⅜ inch.
5. The frozen fruit snack of claim 1, wherein the frozen fruit snack is free of added sugars or preservatives.
6. The frozen fruit snack of claim 1, wherein the individual-portion package has a top seal area that has an extended portion that extends lower than the rest of the top seal, with a tear notch located in the extended portion to facilitate reliable opening of the frozen fruit snack by a consumer, with the extended portion and tear notch being located at one side of the packaged fruit snack.
7. A method of making a frozen fruit snack, comprising the steps of providing Individually Quick Frozen (IQF) fruit; cutting the IQF fruit into fruit chunks about ⅛ inch by ⅜ inch by ⅜ inch; thawing the fruit chunks to about 28 F to about 38 F; filling the thawed fruit chunks into plastic package tubes using a vertical form fill sealing machine; and refreezing the packaged thawed fruit chunks to form a unified frozen fruit pop.
8. The method of claim 7, further comprising the step of forming an upper seal and an extended seal portion with a notch, the extended seal portion and the notch configured at a side of the package to facilitate manual opening of the package.
9. A method of making a frozen fruit snack, comprising the steps of: providing fresh fruit ripened to about brix 11-16; cutting the fresh fruit into fruit chunks about ⅛ inch by ⅜ inch by ⅜ inch; filling the fruit chunks into package tubes using a vertical form fill sealing machine; and freezing the packaged thawed fruit chunks to form a unified frozen fruit pop.
10. The method of claim 9, further comprising the step of forming an upper seal and an extended seal portion with a notch, the extended seal portion and the notch configured at a side of the package to facilitate manual opening of the package.
11. The method of making a frozen fruit snack of claim 9, further comprising the steps of: providing pureed fruit; and wherein the step of filling the fruit chunks into package tubes includes filling pureed fruit together with the fruit chunks.

It is to be understood that even though numerous characteristics and advantages of embodiments disclosed herein have been set forth in the foregoing description, together with details of the structure and function of the embodiments, the disclosure is illustrative only, and changes may be made in detail, especially in matters of shape, size, number, and arrangement of parts within the principles of the disclosure to the full extent indicated by the broad general meaning of the terms in which the appended claims are expressed. Specific elements herein described with relation to any of the embodiments disclosed herein may be combined or substituted to the extent that such combination or substitution is consistent with the general functioning of the embodiments disclosed and the teachings herein, and as consistent with the appended claims.

What is claimed is:

1. A frozen fruit snack comprising:
fruit chunks, wherein the fruit chunks are cut with a minimum dimension no less than about 1/16 inch and a maximum dimension no more than about ½ inch, and a volume between about 0.002 and about 0.14 cubic inches;
the frozen fruit snack is packaged in an individual-portion package that can be opened and consumed without utensil; and
the frozen fruit snack is formed as a unified structure.

2. The frozen fruit snack of claim 1, wherein the fruit chunks have a volume between about 0.008 and about 0.07 cubic inches.

3. The frozen fruit snack of claim 1, wherein the fruit chunks are cut with a minimum dimension about ⅛ inch and a maximum dimension about ⅜ inch.

4. The frozen fruit snack of claim 1, wherein the fruit chunks are cut with dimensions about ⅛ inch by ⅜ inch by ⅜ inch.

5. The frozen fruit snack of claim 1, wherein the frozen fruit snack is free of added sugars or preservatives.

6. The frozen fruit snack of claim 1, wherein the individual-portion package has a top seal area that has an extended portion that extends lower than the rest of the top seal, with a tear notch located in the extended portion to facilitate reliable opening of the frozen fruit snack by a consumer, with the extended portion and tear notch being located at one side of the packaged fruit snack.

7. The frozen fruit snack of claim 1, wherein the individual-portion package has a fin seal, with a tear notch located near one end of the fin seal to facilitate reliable opening of the frozen fruit snack by a consumer.

8. A method of making a frozen fruit snack, comprising the steps of:
providing Individually Quick Frozen (IQF) fruit;
cutting the IQF fruit into fruit chunks about ⅛ inch by ⅜ inch by ⅜ inch;
thawing the fruit chunks to about 28 F to about 38 F;
filling the thawed fruit chunks into plastic package tubes using a vertical form fill sealing machine; and
refreezing the packaged thawed fruit chunks to form a unified frozen fruit pop.

9. The method of claim 8, further comprising the step of forming a fin seal and a tear notch to facilitate manual opening of the package.

10. The method of claim 8, further comprising the step of forming an upper seal and an extended seal portion with a notch, the extended seal portion and the notch configured at a side of the package to facilitate manual opening of the package.

11. A method of making a frozen fruit snack, comprising the steps of:
providing fresh fruit ripened to about brix 11-16;
cutting the fresh fruit into fruit chunks about ⅛ inch by ⅜ inch by ⅜ inch;
filling the fruit chunks into package tubes using a vertical form fill sealing machine; and
freezing the packaged thawed fruit chunks to form a unified frozen fruit pop.

12. The method of claim 11, further comprising the step of forming a fin seal and a tear notch to facilitate manual opening of the package.

13. The method of claim 11, further comprising the step of forming an upper seal and an extended seal portion with a notch, the extended seal portion and the notch configured at a side of the package to facilitate manual opening of the package.

14. The method of making a frozen fruit snack of claim 11, further comprising the steps of:
providing pureed fruit; and
wherein the step of filling the fruit chunks into package tubes includes filling pureed fruit together with the fruit chunks.

15. The method of claim 14, further comprising the step of forming a tear notch to facilitate manual opening of the package.

16. A method of making a frozen fruit snack, comprising the steps of:
providing fruit selected from a list consisting of: fresh fruit ripened to about brix 11-16, Individually Quick Frozen (IQF) fruit, fruit puree, or combination;
cutting any of the provided fruit as required to form fruit chunks about ⅛ inch by ⅜ inch by ⅜ inch;
utilizing a vertical form fill sealing machine adapted to accommodate the fruit chunks to form a package from package film, fill the fruit into the package, seal the package, and form a tear notch to facilitate manual opening of the package; and
freezing the package to form a unified frozen fruit pop.
